(19) United States
(12) Patent Application Publication
(10) Pub. No.: US 2024/0307241 A1
(43) Pub. Date: Sep. 19, 2024

(54) LEG SUPPORT APPARATUS

(71) Applicant: Angglz Support LLC, Atlanta, GA (US)

(72) Inventors: Lana Tobin, Atlanta, GA (US); Dan Schaner, Omaha, NE (US); Carl Gauger, Tucson, AZ (US); Colin Droste, Smithfield, RI (US); Paul Horne, Bonaire, GA (US)

(21) Appl. No.: 18/605,077

(22) Filed: Mar. 14, 2024

Related U.S. Application Data
(60) Provisional application No. 63/451,953, filed on Mar. 14, 2023.

(51) Int. Cl. A61G 5/12

(52) U.S. Cl. CPC A61G 5/127; A61G 2210/10

(57) ABSTRACT

A leg support assembly includes two bodies pivotally coupled to each other. As an example, a proximate body may be sized and shaped to be placed under the thigh when in a sitting position (e.g., below the hamstring). This proximate body may be of a length and width so as to distribute at least a portion of the lower leg's weight. Additionally, a distal body may be placed under the top of a calf such that a hinge is positioned substantially under the popliteal fossa (i.e., the small area behind the knee). Various locking mechanisms may be used to lock the planar body and the distal body in a substantially fixed angle relative to each other. The locking mechanisms may be locked and unlocked to change that angle and then lock the angle in different positions.

### INTRODUCTION

The significance of support for the leg and knee, especially during rest periods, is paramount for various groups of individuals, including those recovering from injuries, surgeries, or suffering from chronic joint conditions. Proper resting support is crucial as it helps in maintaining appropriate alignment, reducing swelling, and preventing further strain on the knee joint, among other benefits. This kind of support is not only beneficial in a therapeutic context but also for everyday relaxation and comfort, particularly for individuals with leg and knee discomfort or mobility issues. For example, leg support aids in improving circulation, reducing stiffness, and enhancing overall comfort during periods of inactivity or sleep.

The current market offerings for resting leg and knee support suffer from several drawbacks, including cost, complexity, comfort, and cleanliness. High-quality support devices specifically designed for resting purposes are often costly, limiting their accessibility for many individuals who require and/or desire them. Many existing resting support solutions are bulky or complicated to set up, making them impractical for everyday use, especially for those with mobility limitations. Additionally, one common issue is the lack of adjustability to accommodate different leg sizes and positions comfortably. This leads to inadequate support or discomfort during prolonged use, which is counterproductive for resting purposes. Further, resting supports that are difficult to clean or maintain can pose hygiene issues, especially for post-surgery patients or those with long-term use requirements.

These limitations highlight the need for an innovative leg and knee (and other joint) support solution specifically designed for resting. Such a solution should be cost-effective, easy to use, adaptable to different body types and resting positions, comfortable for prolonged periods, and simple to maintain and clean. It is with respect to these and other considerations that the technologies described herein have been developed. Also, although relatively specific problems have been discussed, it should be understood that the examples provided are not meant to be limited to solving the specific problems identified in the introduction or elsewhere.

### SUMMARY

The technology generally relates to a leg support assembly. In aspects of the technology, two bodies are pivotally coupled to each other. As an example, a proximate body may be sized and shaped to be placed under the thigh when in a sitting position (e.g., below the hamstring). This proximate body may be of a length and width so as to distribute at least a portion of the lower leg's weight. Additionally, a distal body may be placed under the top of a calf such that a hinge is positioned substantially under the popliteal fossa (i.e., the small area behind the knee). Various locking mechanisms may be used to lock the planar body and the distal body in a substantially fixed angle relative to each other. The locking mechanisms may be locked and unlocked to change that angle and then lock the angle in different positions. This provides, for some applications, the advantage of being able to stabilize a leg (or other joint such as an elbow) in a relatively fixed position and then change the angle to a different locked angle relatively easily. Advantageous, for some applications, include greater well-being, joint preservation, enhanced comfort, pain relief, greater portability, compact storage, and accessibility. Other advantages are contemplated as will be apparent from the disclosure provided or as further explicitly described herein.

In examples, the distal body and/or proximate body may be a substantially planar body. This may be advantageous to allow various sizes of legs and/or arms to be supported. In additional examples, the distal body and/or the proximate body may be convex or another shape to ergonomically cup one or more portions of the leg. The proximate body and the distal body may be a similar shape or may be different. Other features, such as straps to couple the leg to the proximate body or the distal body may be present without changing the scope of the innovative concept.

Aspects of the present technology include a support assembly with proximate body having a first end opposite a second end, wherein the second end is rotatably coupled to a coupling end of a distal body. The support assembly may also include a locking mechanism removably engaged with a portion of the proximate body and a portion of a distal body such that an angle between the proximate body and the distal body remains relatively fixed when the lock mechanism is in a locked position.

Various features may also be present or used with the innovative support assembly. For example, the second end may be rotatably coupled to the coupling end at least in part through, and a plurality of knuckles may protrude from the second end and interleave with a corresponding one or more knuckles protruding from the coupling end of the distal body. A hinge pin may be inserted into a center hole of each of the plurality of knuckles and a center hole of each of the one or more knuckles.

Additionally, the support the distal body may include a support element disposed along at least a portion of an edge substantially parallel to an axis of rotation, wherein the support element comprises a protrusion along the at least a portion of the edge.

Further, the locking mechanism may include a spring coil having a spring bore and a front end opposite a back end; a rod disposed within the spring bore, the rod having a first end opposite a second end; a flange circumferential disposed near the second end of the rod, wherein the front end of the spring abuts a face of the flange; and a grip element having a body and an opening, wherein the first end of the rod is disposed within the opening of the body. In examples, the back end of the spring coil abuts an engagement face of the one or more knuckles or the plurality of knuckles. In further examples, a guide locking hole is disposed within an interior wall of at least one knuckle of the plurality of knuckles. The rod may be coupled to a receiving element at least one knuckle of the plurality of knuckles. The second end of the rod may be disposed through the guide locking hole to an opening on a locking hole of the one or more knuckles.

The angle of the support assembly may be locked in a variety of positions, including but not limited to about 35°, about 45°, about 55°, about 65°, about 75°, about 85°, about 95°, about 105°, about 115°, about 125°, about 135°, about 145°, about 155°, about 165°, and about 175°. The proximate body may include a padding disposed on a top side of the proximate body opposite a bottom side.

The locking mechanism may comprise different mechanisms suitable for locking a proximate body in a relatively fixed angle with respect to the distal body. For example, a pawl and a biasing element may be used. The pawl may be adapted to engage with at least one tooth of center knuckle of the one or more knuckles. In examples, the proximate body is a planar body and the distal body is a planar body.

These and various other features, as well as advantages that characterize the systems and methods described herein, will be apparent from a reading of the following detailed description and a review of the associated drawings. Additional features are set forth in the description that follows and, in part, will be apparent from the description or may be learned by practice of the technology. The benefits and features of the technology will be realized and attained by the structure particularly pointed out in the written description and the claims as well as the appended drawings. It is to be understood that both the foregoing introduction and the following detailed description are exemplary and explanatory and are intended to provide further explanation of the innovative technology as claimed.

### BRIEF DESCRIPTION OF THE DRAWINGS

FIG. 1A illustrates a front perspective view of an example leg support assembly.

FIG. 1B illustrates a back perspective view of an example leg support assembly.

FIG. 2A illustrates a bottom view of an example proximate planar body of a leg support assembly.

FIG. 2B illustrates a top perspective view of an example proximate planar body of a leg support assembly.

FIG. 2C illustrates a side view of an example proximate planar body of a leg support assembly.

FIG. 2D illustrates a bottom perspective view of an example proximate body of a leg support assembly.

FIG. 2E illustrates a top view of an example proximate body of a leg support assembly.

FIG. 3A illustrates a top perspective view of an example distal planar body.

FIG. 3B illustrates a bottom perspective view of an example distal planar body.

FIG. 4 illustrates a detailed view of a hinge mechanism.

FIG. 5 illustrates a detailed view of an example locking mechanism coupled to a proximate planar body and a distal planar body.

FIG. 6A illustrates a perspective view of an example locking mechanism.

FIG. 6B illustrates a perspective, exploded view of an example locking mechanism.

FIG. 7 illustrates an example leg support assembly in a closed position.

FIG. 8 illustrates an alternative locking mechanism coupled to a proximate planar body and a distal planar body.

### DETAILED DESCRIPTION

Although the innovative technologies have been explained in relation to various examples and embodiments, it is to be understood that many other possible modifications and variations can be made without departing from the spirit and scope of the disclosed technology. Indeed, one skilled in the art will appreciate the foregoing detailed description is provided by way of illustration and not limitation. The examples presented herein are intended to facilitate a clear understanding of the innovative technologies disclosed, and they are not exhaustive of the potential embodiments or examples encompassed by the scope of this disclosure. Those skilled in the art will readily recognize alternative implementations and variations that remain within the broad principles of the innovative technologies described herein. Therefore, it should be understood that the scope of the present disclosure encompasses all such modifications and alternative/additional embodiments and examples as fall within the true spirit and scope of the appended claims. While certain elements may conventionally be understood to suggest an order (e.g., a first support element, a second support element, etc.) no order is intended. Rather, the use of the terms first, second, third, etc., are meant to distinguish a particular element from another element similarly labeled.

All numerical values presented herein should be understood to represent exemplary values. These values are provided to illustrate preferred embodiments for some applications and to facilitate the understanding of the innovative technology disclosed herein. It is expressly understood that these numerical values are not absolute but are subject to a standard tolerance level commonly recognized in the field, unless specifically stated otherwise

Accordingly, variations in these values, including but not limited to tolerances of 1%, 5%, 10%, or even 15%, are to be considered within the scope of the present invention. Such variations may depend on specific applications, manufacturing techniques, material properties, or environmental conditions, among other factors. The mention of specific numerical values and tolerances herein is intended to illustrate and not to limit the invention. It will be appreciated by those skilled in the art that other values, both greater and lesser, may be used to achieve the function of the disclosed innovation, without deviating from its scope as defined in the appended claims.

Throughout this disclosure, terms denoting orientation, position, or directional relationships such as “top,” “bottom,” “proximate,” and “distal” are used for convenience and clarity in describing the invention and its components as depicted in the figures. These terms are not intended to imply a specific orientation regarding the Earth's gravity, a particular direction of use, or any preferred configuration. Instead, they are to be understood as providing relative descriptions to facilitate the explanation of the relationships and positioning of various components of the invention with respect to each other.

It is to be expressly understood that such terms are used in a relative sense only and are interchangeable depending on the orientation or configuration in which the invention is utilized or observed. Accordingly, the use of these terms should not be interpreted to limit the invention to any specific orientation or arrangement. Variations in orientation, arrangement, and positional terms, encompassing but not limited to reversals, rotations, or other transformations, are considered within the scope of the present invention. This flexibility in interpretation ensures that the innovative aspects of the technology can be applied in various configurations, orientations, or environments without departing from the core principles and functionality disclosed herein.

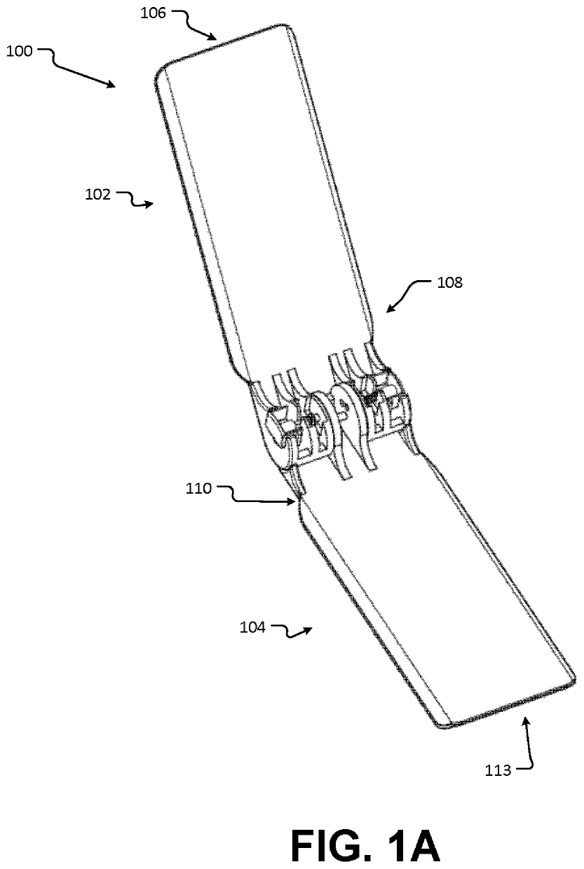

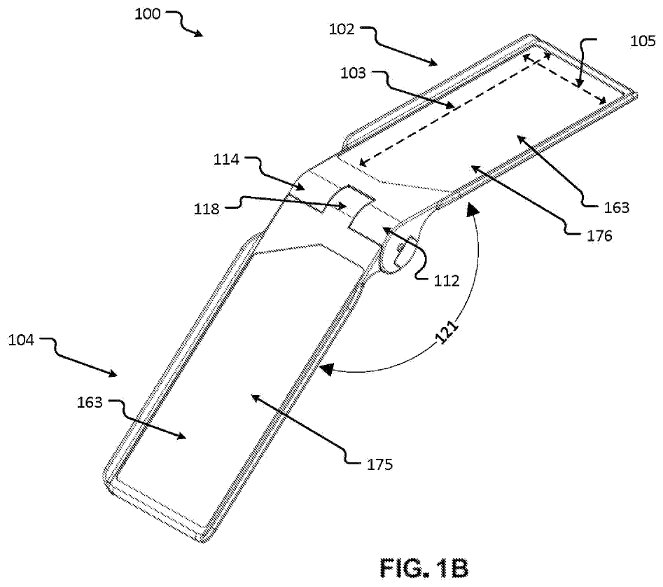

With reference to the Figures, FIG. 1A illustrates a front perspective view of an example leg support assembly 100, and FIG. 1B illustrates a back perspective view of an example leg support assembly 100. A leg support assembly 100 includes a proximate body 102. The proximate body 102 is illustrated as substantially planar with a length 103 and a width 105. In examples, the length 103 and the width 105 are chosen such that, when used as a leg support, the proximate body 102 can comfortably support a part of a leg (e.g., a bottom portion of the thigh). For example, the length may be about 4 inches, about 5 inches, about 6 inches, about 7 inches, or about 8 inches. The width may be about 3 inches, about 4 inches, about 5 inches, about 6 inches, or about 7 inches. Further, the proximate body 102 is illustrated as being substantially similar in size as the distal body 104. This may be advantageous for some applications, it will be appreciated that other configurations are contemplated. For example, the proximate body may be relatively longer than the distal body 104. Such configuration may be advantageous when a user wishes to more fully disperse the weight of the lower leg across a larger portion of the hamstring. In other examples, a more compact size and shape are desired. The example proximate body 102 includes a first end 106 and second end 108. The second end 108 is rotatably coupled to a distal body 104 at a coupling end 110.

The distal body 104 and the proximate body 102 may be made of a variety of materials. For example, the distal body 104 and the proximate body 102 may be made of a rigid or semi-rigid plastic, metal, wood, or other material capable of supporting at least a portion of a leg. In examples, the proximate body 102 and the distal body 104 are of a unitary construction. For example, plastic-injection molding, 3-D printing or some other technology capable of creating a unitary body may be employed. In other examples, a variety of materials are used. In some examples, a pad, such as pad 163 are affixed to the top 176 of a distal body 104 and/or the top 175 of the proximate body 102. The pad 163 may be desirous to aid in comfort during use.

The distal body 104 and the proximate body 102 are illustrated as rotatably coupled to each other about an axis 181. An angle 121 is, in examples, defined by the angle between a line parallel to the plane formed by proximate body 102 and orthogonal to the axis of rotation 181, and a line parallel to a plane formed by a distal body 104 and orthogonal to the axis of rotation 181. In examples, angle 121 is defined by a first line 183 that is parallel to an edge of the proximate planar body and a second line 185 that is parallel to an edge of the distal planar body. In examples, a hinge pin 200 defines the axis of rotation.

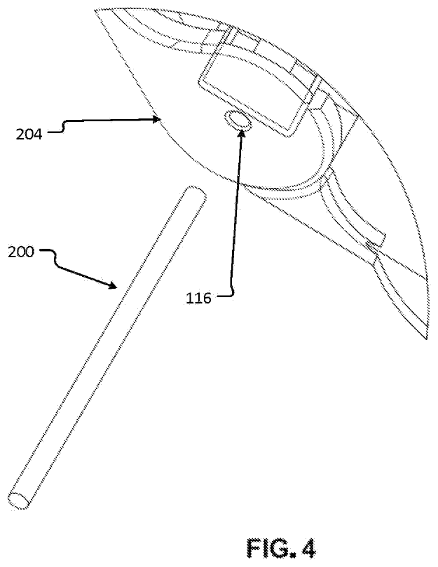

In some examples, the second end 108 has a plurality of knuckles interleaved with one or more knuckles of the distal body 104. As illustrated, the second end 108 comprises a first knuckle 112 and a second knuckle 114 interleaved with a center knuckle 118 of a coupling end 110 of a distal body 104. As illustrated in further detail in FIG. 4, a hinge pin 200 is disposed within center holes 116 of the plurality of knuckles. The illustrated first knuckle 112 and second knuckle 114 each have a center hole 116 capable of receiving the hinge pin 200.

The illustrated hinge pin 200 additionally passes through a center hole of the one or more knuckles of a distal body 104. That is, in examples, the distal body 104 also includes a center knuckle 118 that has a center hole 120 aligned with the center holes 116 of the plurality of knuckles such that a hinge pin 200 may be inserted through each of the center holes 116 and center holes 120. In the particular example illustrated, the hinge pin 200 is inserted into the center holes of a plurality of knuckles on a second end 108 of a proximate body 102 and the one or more knuckles of a distal body 104. This allows, for some uses, for the first end 106 of the proximate body 102 and the distal end 113 of the distal body 104 to be moved apart while the second end 108 of the proximate body 102 and the coupling end 110 of the distal body 104 remain relatively fixed. In this way, the leg support assembly 100 is capable of forming various angles 121. The angle 121 may be fixed (e.g., capable of withstanding some rotational forces without, such as the force caused by supporting a leg) and keeping a relatively fixed angle 121. Fixing angle 121 may occur using various means, such as engagement with a plurality of teeth and/or pin system, each of which is further described herein. Having the leg support assembly 100 be able to move between various angles 121 may be advantageous for certain applications. For example, where it is desirous to maintain a leg elevated and supported at various angles, the angle 121 may be fixed such that the angle 121 resists change when a rotational force is applied.

In some examples, one or more support elements are present on the proximate body 102 and/or the distal body 104. As illustrated, a first support element 122 and second support element 124 extend along a first edge and a second edge of the proximate body 102, respectively. Additionally, a third support element 127 and a fourth support element 129 are illustrated extending along a third edge and a fourth edge, respectively, of the distal body 104. In examples, the support elements provide structural support so that a body (e.g., the proximate body 102 and the distal body 104) have a higher load-bearing capacity than a similarly designed body without said support element. One advantage of having a support element is that, for some applications, the support element provides greater structural integrity while having relatively less weight and material than a uniformly thicker body. While the support elements 122, 124, 127, and 129 are illustrated as upwardly angled protrusions at an edge running orthogonal to a rotation of axis 181, it will be appreciated that other support elements are contemplated, such as protrusions on a proximate body or distal body along a center line, and/or protrusions running parallel to an axis of rotation. It will further be appreciated that support elements may protrude from a top side and/or a bottom side of a proximate body and a distal body without deviating from the scope of the innovative technologies described herein.

FIG. 4 illustrates a detailed view of a hinge mechanism that may be employed with the disclosure herein. As illustrated, a hinge pin 200 may be removably inserted into various center holes 116 of a plurality of knuckles on a proximate body 102 and threaded through at least one knuckle of a distal body 104. In the example illustrated, the hinge pin 200 is inserted into a first knuckle 112 and a second knuckle 114 of a proximate body 102. Additionally, the hinge pin 200 is inserted into a center hole 120 on a distal body 104. In this way, hinge pin 200 provides an axis of rotation about which a proximate body 102 and a distal body 104 may rotate. For example, a proximate body 102 and a distal body 104 may rotate to form an angle 121.

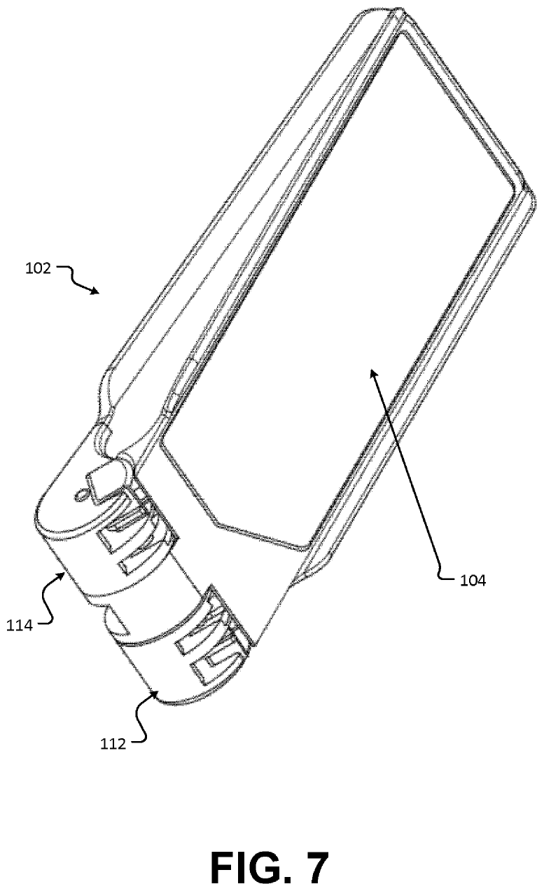

As may be appreciated from FIG. 1B and FIG. 7, the proximate body 102 and the distal body 104 may rotate about the hinge pin 200 to form various angles 121. In examples, the proximate body 102 and the distal body 104 may rotate about hinge pin 200 to form an angle 121 of about 0°, about 15°, about 25°, about 35°, about 45°, about 55°, about 65°, about 75°, about 85°, about 95°, about 105°, about 115°, about 125°, about 135°, about 145°, about 155°, about 165°, and about 175°. Various mechanisms may be employed to lock angle 121 so that the proximate body 102 and the distal body 104 remain in a relatively fixed position about the axis of rotation 181. For example, a pin mechanism, a ratchet locking mechanism, or other mechanisms now known or later developed may be employed to keep the proximate body 102 and the distal body 104 in a relatively fixed angle 121.

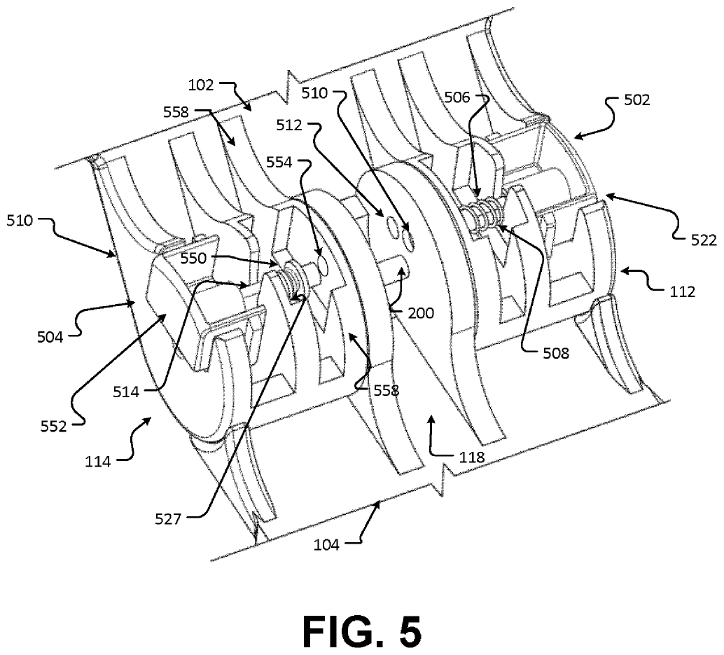

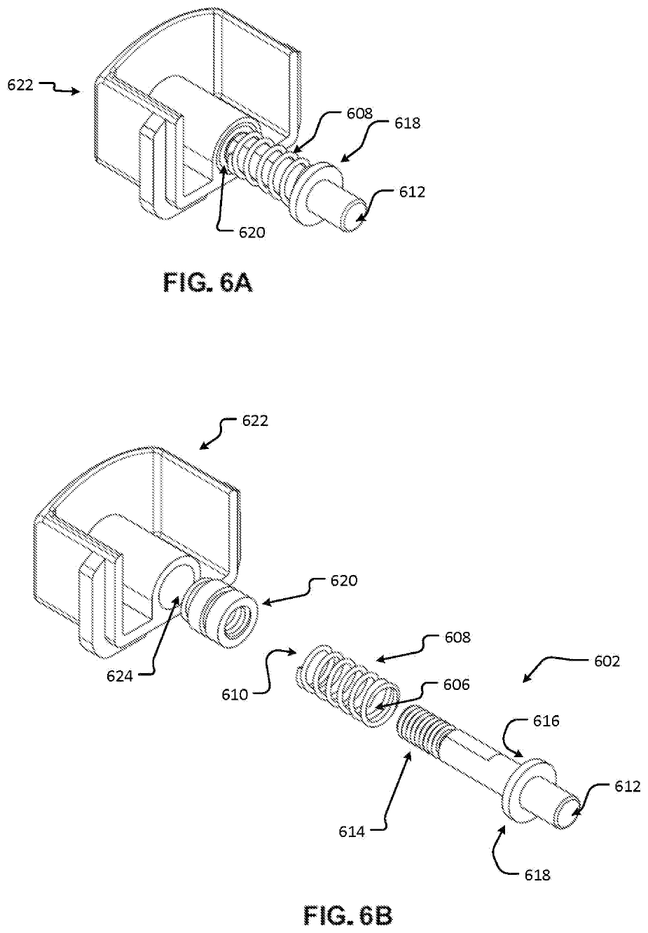

FIG. 5 provides examples of a first locking mechanism assembly 502 being used to lock a first knuckle 112 of a proximate body 102 to a center knuckle 118 of a distal body 104. FIG. 5 additionally provides an example of a second locking mechanism assembly 504 capable of locking a second knuckle 114 to a center knuckle 118. The second locking mechanism assembly 504 is illustrated as being in the unlocked position (i.e., the second locking mechanism assembly 504 is not locking the center knuckle 118 to the second knuckle 114). It will be appreciated that elements like numbered as those described above will have the same or similar properties as those described above and below. Further example details of the various elements of the first locking mechanism assembly 502 and the second locking mechanism assembly 504 are described with reference to FIGS. 6A and 6B.

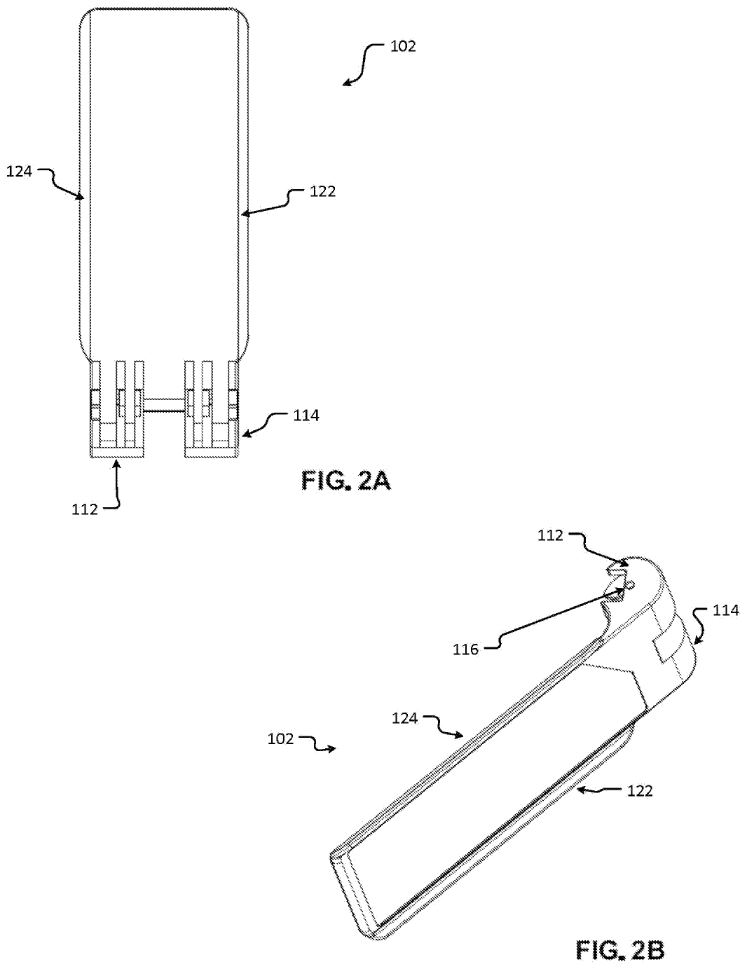

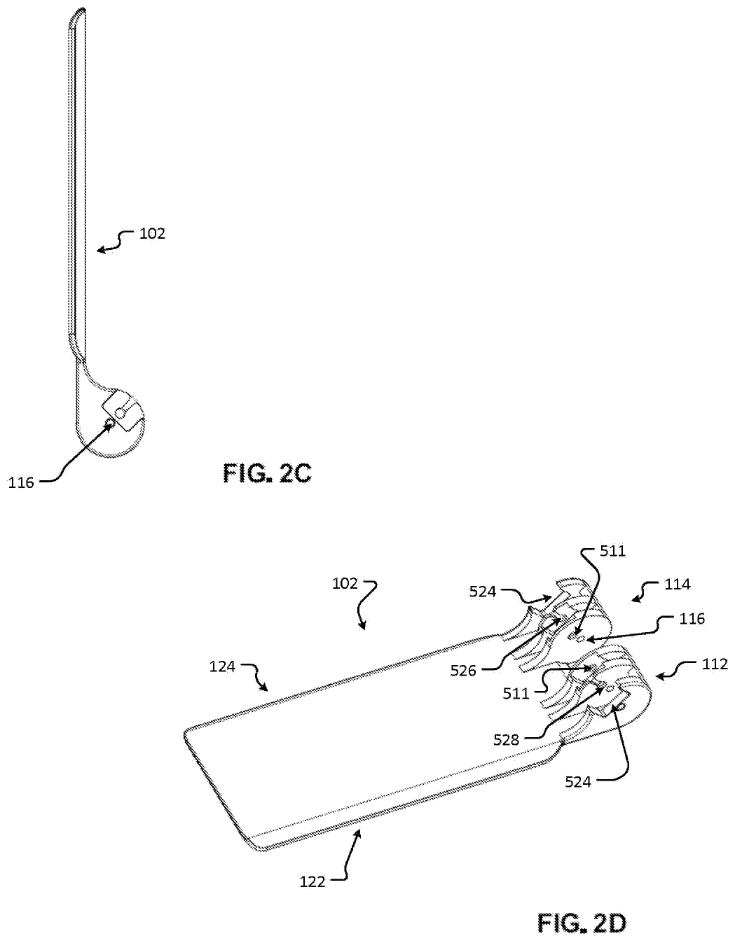

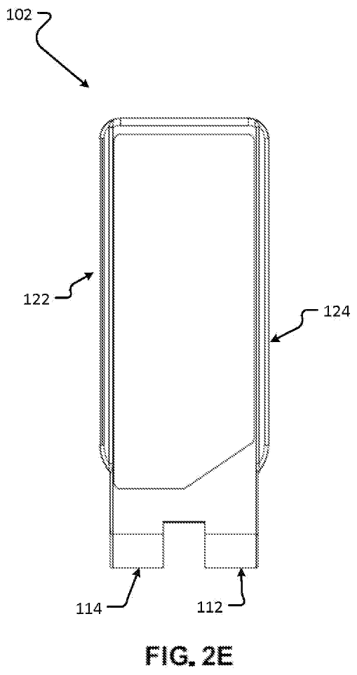

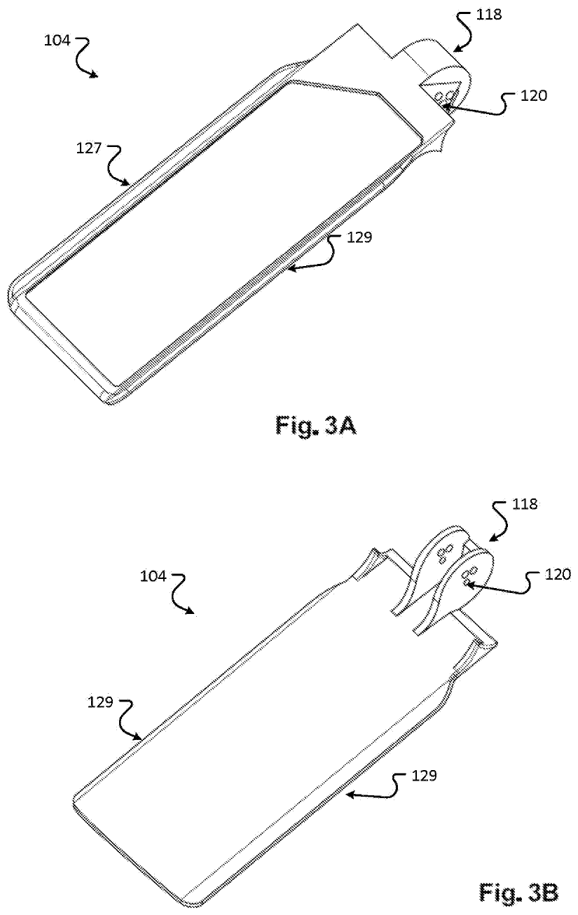

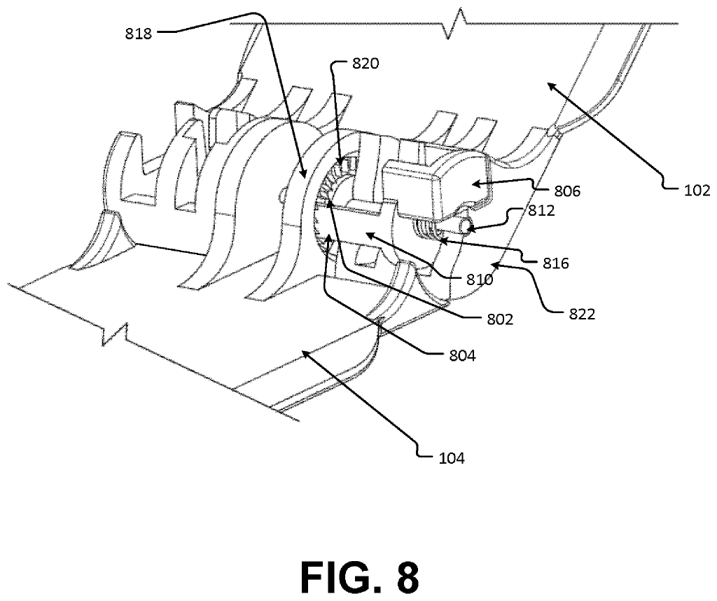

As will be appreciated from FIG. 5, the first locking assembly 502 includes a first spring coil 506 that provides a biasing force parallel to the axis of rotation defined by a length of a hinge pin 200 such that the first end of the first rod 508 removably engages with both a guide locking hole 511 (labeled in FIG. 2D) of a proximate body 102 and a first locking hole 510 of the center knuckle 118 of the distal body 104. The guide locking hole 511 is illustrated as having a guide locking hole 511 aids, for some uses, to keep the rod aligned under stress. Various other means of removably coupling a center knuckle 119 to a second knuckle 114 are contemplated, such as a pawl and teeth wheel mechanism as further described with reference to FIG. 8.

Additional locking holes may be used to lock angle 121 at various angles. For example, FIG. 5 illustrates a second locking hole 512 disposed on the center knuckle 118. It will be appreciated that disengaging the first end of the first rod 508 from the first locking hole 510 allows the first knuckle 112 to rotatably pivot about the hinge pin 200 (provided that the second locking mechanism assembly 504 is also disengaged, in the example illustrated). It will further be appreciated that engaging the first rod 508 with the first locking hole 510 will lock angle 121 at a different angle than engaging the first rod 508 with the second locking hole 512. As such, angle 121 may be locked at a variety of angles corresponding to one or more locking holes disposed on a center knuckle. The locking holes, in examples, are circumferentially disposed about the center hole 120 of the center knuckle 118. In examples, the distance between each locking hole and the center hole is relatively equal.

Additionally illustrated is a first grip 522. First grip 522 is disposed within a slot 524 adapted to receive the first grip 522 of the second knuckle 114. The first rod 508 is slotted into a first receiving element 526 of the second knuckle 114. In the example illustrated, the first receiving element 526 is a notch of a center wall of the second knuckle 114. As further illustrated in FIG. 2D, the first receiving element 526 and the second receiving element 528 may be sized and shaped to receive and robustly couple various rods, such as the first rod 508 and the second rod 514, respectively, via a press fit or friction fit. First grip 522 may be made of a variety of materials, such as a rigid plastic of metal.

Further illustrated in FIG. 5 is the second locking mechanism assembly 504, which includes a second spring coil 550. Disposed within the second spring coil 550 is second rod 514, having a flange disposed around a first end. Second spring coil 550 is illustrated as being compressed relative to first spring coil 506. A second spring coil 550 may engage with an engagement face 527 of a center support wall of the second knuckle 114. This may occur by a user applying a force (for example, pulling on the second grip 552 in a direction parallel to the axis of rotation and away from the center hole 120). This allows, for the illustrated second locking mechanism assembly 504, the first knuckle 112 to pivotally rotate about an axis parallel to the hinge pin 200 relative to the center hole 118.

A second guide locking hole 554 is disposed about an interior wall 558 of the second knuckle 114. The illustrated second guide locking hole 554 guides the flange end of the second rod 514 to a locking hole disposed on the center knuckle. For example the first rod 508 may engage with the first locking hole 510 at the same time that the second rod 514 engages with a corresponding hole. As illustrated, the second rod 514 is not inhibiting the rotation of either the proximate body 102 or the distal body 104 about an axis of rotation 181. It will be appreciated that more or less locking holes may be present without deviating from the scope of the innovative technologies described herein. It will further be appreciated that the locking holes may be located on either an interior wall of a plurality of knuckles and/or the center knuckle without deviating from the scope of this innovative technologies described herein.

FIG. 6A illustrates a perspective view of an example locking mechanism assembly 600, and FIG. 6B illustrates an exploded perspective view of the example locking mechanism assembly 600, each of which may be used in combination with the innovative technologies described herein. For example, the first locking mechanism 502 and the second locking mechanism assembly 504 described with reference to FIG. 5 may be the same or similar to the locking mechanism described with reference to FIGS. 6A-6B. As illustrated, locking mechanism 600 includes a spring coil 604 having a spring bore 606. The illustrated spring coil 604 further includes a front end 608 opposite a back end 610. Disposed within the spring bore 606 is a rod 602. The illustrated rod 602 comprises a first end 612 opposite a second end 614. The first end 612 includes a flange having a face 616.

The example locking mechanism assembly 600 also includes a grip 622, which may be sized and shaped such that a user can interact with the grip 622 to allow a leg support assembly, such as the leg support assembly described herein, to move about an angle (e.g., angle 121) or to engage with various elements of the leg support system to lock a leg support assembly at a specific angle. As illustrated, the second end 614 of the rod is disposed within a nut 620 that is disposed within an opening 624 defined by the body of the grip 622. The nut 620 may be press fit into the grip element 622. The second end 614 of the rod 602 may include a threaded engagement to engage with the nut 620. Other means of coupling are contemplated, including press fit and/or adhesives.

The example locking mechanism assembly 600 may be used to fix an angle 121 by engaging with various structural elements of the proximate body 102 and/or the distal body 104. In examples, the first end 612 may removably engage with one or more locking holes located on a knuckle of the proximate body 102 and/or the distal body 104 as described further herein.

FIG. 8 provides a detailed view of an alternative example of a locking mechanism assembly 800 that may be used with the innovative technologies described herein. As illustrated, a grip 806 is coupled to rod 812. The rod 812 is disposed within a spring 816 that provides a biasing force against a pawl 810 that engages with teeth 820 disposed within a support wall 818 of a center knuckle 821. For example, an outer support wall 822 may provide a counter acting force against the spring. The teeth 820 may be removably inserted into a support wall 818 or may form part of the unitary body of the center knuckle 118. A user may interact with a grip 806 to engage and/or disengage the pawl 810 with the plurality of teeth 820. One advantage to the system illustrated is that it may provide a variety of angles.

It will be appreciated that the leg support assembly may be to support other joints, such as an elbow or back without deviating from the scope of the technology.

It will be clear that the systems and methods described herein are well adapted to attain the ends and advantages mentioned as well as those inherent therein. Those skilled in the art will recognize that the methods and systems within this specification may be implemented in many manners and as such is not to be limited by the foregoing exemplified embodiments and examples. In other words, functional elements being performed by a single or multiple components and individual functions can be distributed among different components. In this regard, any number of the features of the different embodiments described herein may be combined into one single embodiment and alternate embodiments having fewer than or more than all of the features herein described as possible.

What is claimed:

1. A support assembly comprising:
a proximate body having a first end opposite a second end, wherein the second end is rotatably coupled to a coupling end of a distal body;
a locking mechanism removably engaged with a portion of the proximate body and a portion of a distal body such that an angle between the proximate body and the distal body remains relatively fixed when the lock mechanism is in a locked position.

2. The support assembly of claim 1, wherein the second end is rotatably coupled to the coupling end at least in part through:
a plurality of knuckles protruding from the second end that interleave with a corresponding one or more knuckles protruding from the coupling end of the distal body;
a hinge pin inserted into a center hole of each of the plurality of knuckles and a center hole of each of the one or more knuckles.

3. The support assembly of claim 2, wherein the distal body includes a support element disposed along at least a portion of an edge substantially parallel to an axis of rotation, wherein the support element comprises a protrusion along the at least a portion of the edge.

4. The support assembly of claim 2, wherein the locking mechanism comprises:
a spring coil having a spring bore and a front end opposite a back end;
a rod disposed within the spring bore, the rod having a first end opposite a second end;
a flange circumferential disposed near the second end of the rod, wherein the front end of the spring abuts a face of the flange;
a grip element having a body and an opening, wherein the first end of the rod is disposed within the opening of the body.

5. The support assembly of claim 4, wherein the back end of the spring coil abuts an engagement face of the one or more knuckles or the plurality of knuckles.

6. The support assembly of claim 5, further comprising:
a guide locking hole disposed within an interior wall of at least one knuckle of the plurality of knuckles.

7. The support assembly of claim 6, wherein the rod is coupled to a receiving element at least one knuckle of the plurality of knuckles.

8. The support assembly of claim 7, wherein the second end of the rod is disposed through the guide locking hole to an opening on a locking hole of the one or more knuckles.

9. The support assembly of claim 1, wherein the angle is selected from the group consisting of: about 35°, about 45°, about 55°, about 65°, about 75°, about 85°, about 95°, about 105°, about 115°, about 125°, about 135°, about 145°, about 155°, about 165°, and about 175°.

10. The support assembly of claim 1, wherein the proximate body includes a padding disposed on a top side of the proximate body opposite a bottom side.

11. The support assembly of claim 2, wherein the locking mechanism comprises a pawl and a biasing element adapted to engage with at least one tooth of center knuckle of the one or more knuckles.

12. The support assembly of claim 1, wherein the proximate body is a planar body and the distal body is a planar body.
